(19) United States
(12) Patent Application Publication
(10) Pub. No.: US 2009/0165254 A1
(43) Pub. Date: Jul. 2, 2009

(54) HOUSING OF FOLDABLE DEVICE

(75) Inventor: ZI-MING TANG, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/143,832

(22) Filed: Jun. 23, 2008

(30) Foreign Application Priority Data
Dec. 27, 2007 (CN) 200710203484.X

(51) Int. Cl. E05D 11/00

(52) U.S. Cl. 16/404

(57) ABSTRACT

An exemplary housing of a foldable device includes a first cover, a second cover, and a button positioned on the second cover. The first cover includes a first latching member. The button includes a main body, a second latching member, and an elastic portion. The second latching member connects to the main body. The second latching member is configured for engaging with the first latching member. The main body includes a contact receiving surface and a bottom surface opposite to the contact receiving surface. A part of the contact receiving surface is exposed out of the second cover and the elastic portion connects at least one of the contact receiving surface and the bottom surface.

### BACKGROUND OF THE INVENTION

1. Field of the Invention

The present invention relates to a housing of a foldable device.

2. Discussion of the Related Art

Referring to FIGS. 7 and 8, a housing 10 of a foldable electric device is shown. The housing 10 includes a bottom cover 11, a top cover 12, a sliding member 13, a hook 14, and a spring 15. The bottom cover 11 defines a latching portion 111 in an edge thereof. The top cover 12 defines a rectangular groove 121 on an edge thereof and forms a resisting member 123 adjacent to the rectangular groove 121. The sliding member 13 is a rectangular block in shape. The sliding member 13 is positioned in the rectangular groove 121 and is able to slide along in the rectangular groove 121. The hook 14 is configured for engaging with the latching portion 111. The hook 14 is fixed to the sliding member 13 so that the hook 14 is able to slide together with the sliding member 13. One end of the spring 15 resists the resisting member 123 and the other end of the spring 15 resists the hook 14 so that the hook 14 and the sliding member 13 are kept at one end of the rectangular groove 121.

In use, if an user wants to open the top cover 12, the user has to pry the sliding member 13 and drive the sliding member 13 to move towards the other end of the rectangular groove 121 with a finger. However, the sliding member 13 is generally designed to be of small sizes. As a result, the contact receiving surface of the sliding member 13 is relatively small. In addition, when driving the sliding member 13, the finger exerts a force to slide the sliding member 13, and likely causing slippage between the finger and the sliding member 13. As a result, it is difficult to open the top cover 12.

Therefore, a new housing of a foldable device is desired in order to overcome the above-described shortcoming.

### SUMMARY

A housing of a foldable device includes a first cover, a second cover, and a button positioned on the second cover. The first cover includes a first latching member. The button includes a main body, a second latching member, and an elastic portion. The second latching member connects to the main body. The second latching member is configured to engage with the first latching member. The main body includes a contact receiving surface and a bottom surface opposite to the contact receiving surface. At least a part of the contact receiving surface is exposed out of the second cover and the elastic portion connects at least one of the contact receiving surface and the bottom surface. The button can be pushed to disengage the first latching member from the second latching member.

Other advantages and novel features will become more apparent from the following detailed description of various embodiments, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present housing of the foldable device. Moreover, in the drawings, like reference numerals designate corresponding parts throughout several views, and all the views are schematic.

FIG. 1 is an exploded, isometric view of a housing of a foldable device in accordance with one embodiment of the present invention.

FIG. 2 is an isometric view of a button of the foldable device of FIG. 1.

FIG. 3 is an isometric view of the button 24 in FIG. 2, from a different aspect.

FIG. 4 is an assembled, isometric view of the housing in FIG. 1 when it is folded.

FIG. 5 is a side, cross-sectional view of the housing of FIG. 4, taken along the line V-V in FIG. 4.

FIG. 6 is an enlarged view of the circled portion VI in FIG. 5.

FIG. 7 is an exploded, isometric view of a conventional housing of a foldable device.

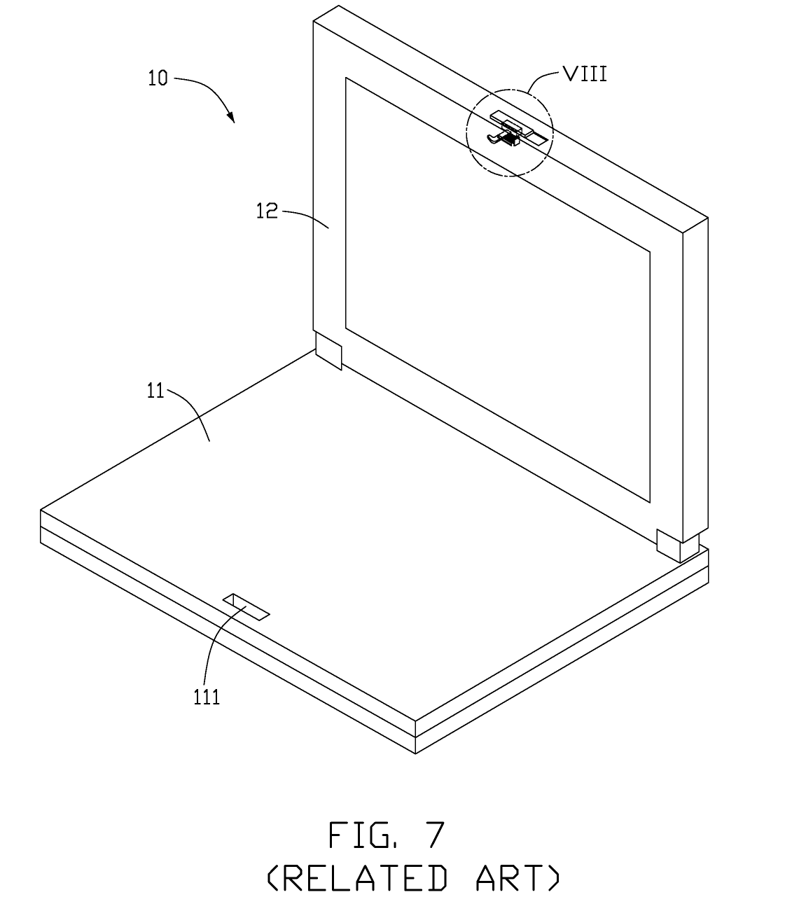

FIG. 8 is an enlarged view of the circled portion VIII in FIG. 7.

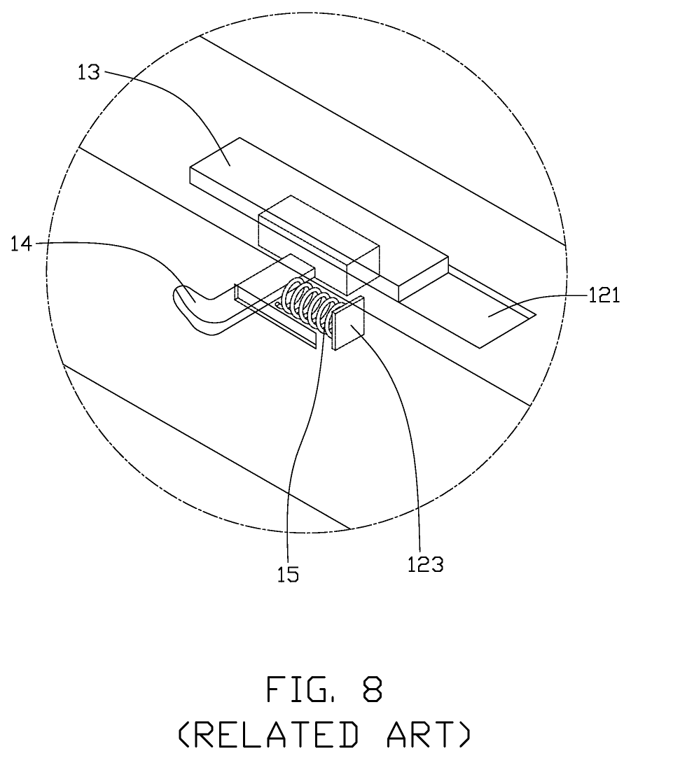

### DETAILED DESCRIPTION OF THE PREFERRED EMBODIMENTS

Reference will now be made to the drawings to describe preferred embodiments of the present housing of the foldable device in detail.

The present housing is used for foldable devices, such as notebooks, cell phones, media players, and so on. In a preferred embodiment, a housing of a notebook is taken as exemplary device to describe the housing of the present invention.

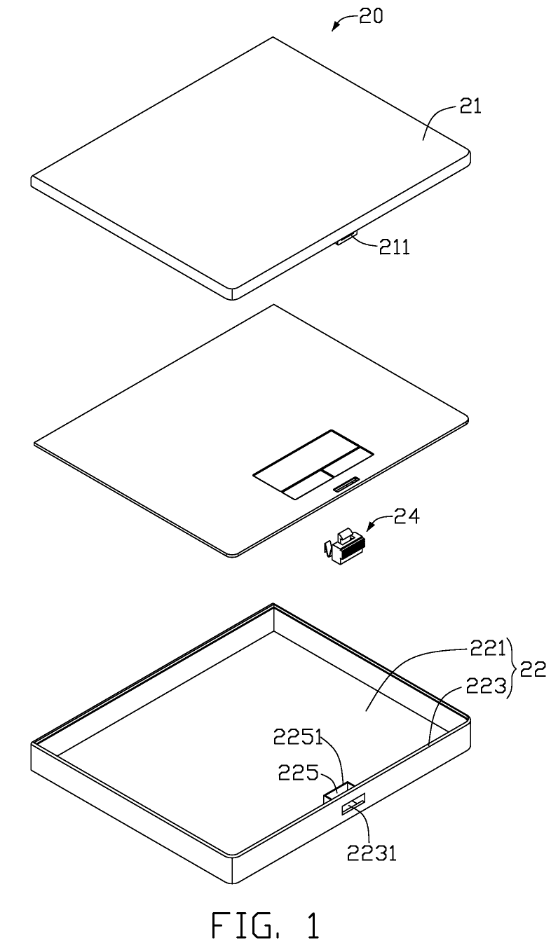

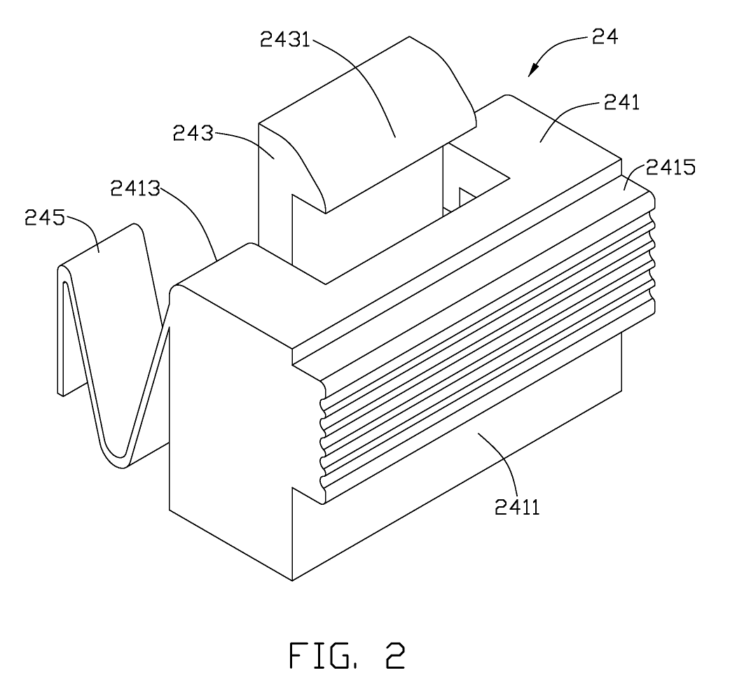

Referring to FIGS. 1 and 2, a housing 20 of the preferred embodiment for a notebook is shown. The housing 20 includes a first cover 21, a second cover 22, and a button 24 positioned on the second cover 22. The first cover 21 includes a first latching member 211 which is basically a hook holder. The first latching member 211 is a portion of the first cover 21. The button 24 includes a main body 241, a second latching member 243, and two elastic portions 245. The second latching member 243 is a portion of the button 24. Both the second latching member 243 and the elastic portions 245 connect with the main body 241. The second latching member 243 is a resilient hook. The second latching member 243 is configured for engaging with the first latching member 211 on the first cover 21 so that the first cover 21 can be latched/secured to the second cover 22.

The second cover 22 includes a base 221 and a plurality of sidewalls 223. The sidewalls 223 extend from the base 221. One of the sidewalls 223 (hereinafter referred to as front sidewall 223a) defines an opening 2231. The sidewall 223 also forms a latching housing 225 adjacent to the opening 2231 on the inner surface thereof. The latching housing 225 is configured for receiving the button 24. A side surface of the latching housing 225 forms a resisting portion 2251, which is substantially parallel to the sidewall 223.

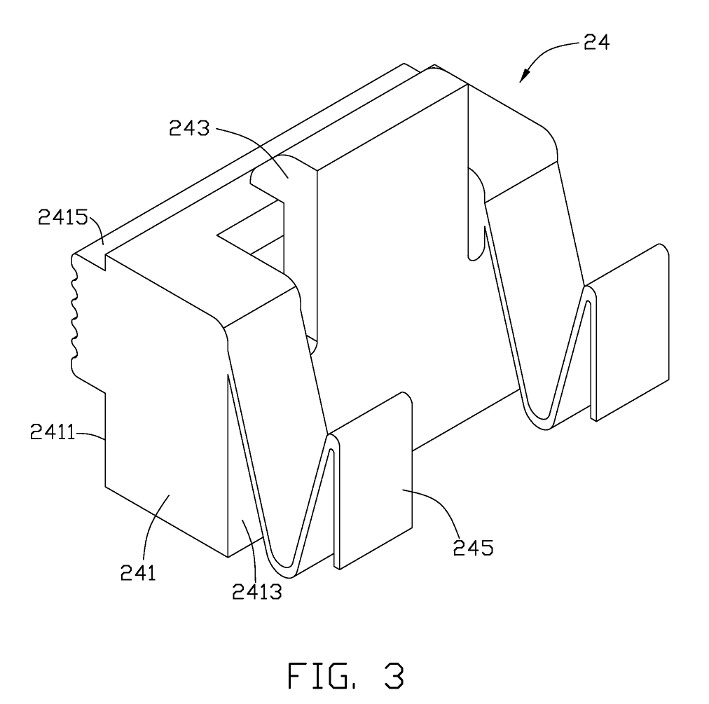

Referring to FIGS. 2 and 3, the main body 241 is substantially a rectangular block in shape, the size of the main body 241 is smaller than that of the latching housing 225 such that the main body 241 can be received in the latching housing 225. The main body 241 includes a contact receiving surface 2411 and a back surface 2413. The contact receiving surface 2411 and the back surface 2413 are on opposite sides of the main body 241. The elastic portions 245 are formed on the back surface 2413. In addition, the contact receiving surface 2411 forms a touching protrusion 2415, the touching protrusion 2415 is able to protrude through the opening 2231.

In the illustrated embodiment, the second latching member 243 is a resilient hook, and it is integrally formed with the main body 241. In addition, a top surface 2431 of the second latching member 243 is curved, so that the first latching member 211 can easily slide against it in locking and unlocking the first cover 20 and second cover 22.

The elastic portions 245 are integrally formed with the main body 241, with one end connected to the main body 241, and the other loose, and the elastic portions 245 are substantially an “S”-shaped elastic members in shape.

In an assembly process, the button 24 is positioned in the latching housing 225, the touching protrusion 2415 is positioned in the opening 2231, the loose ends of the elastic portions 245 resist the resisting portion 2251. As a result, the main body 241 is able to move back and forth in directions substantially perpendicular to the resisting portion 2251.

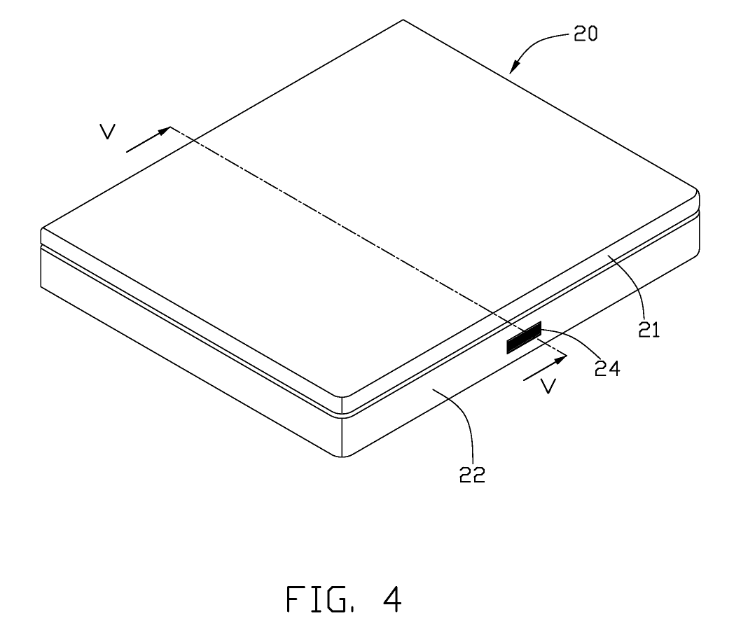

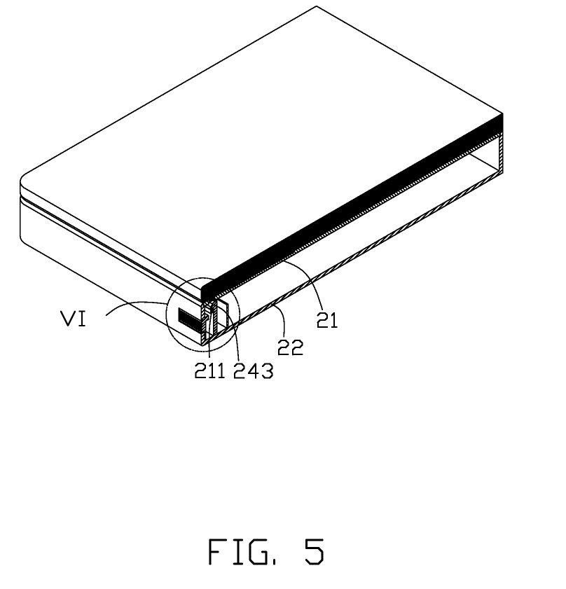

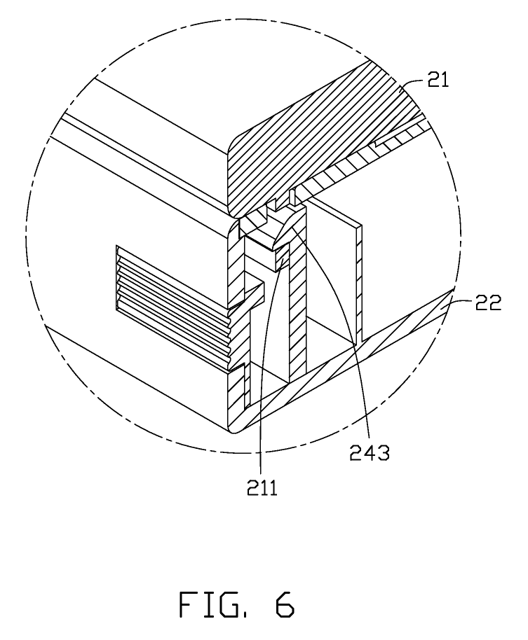

Referring to FIGS. 4 through 6, when the notebook is in a folded state, the first cover 21 is closed and abuts the second cover 22. In this state, the first latching member 211 is latched/secured to the second latching member 243.

To open the first cover 21, the touching protrusion 2415 is pushed inward, then the main body 241 slides towards the resisting portion 2251 and exerts a force on the elastic portions 245, thus the elastic portions 245 are compressed and accumulate energy. As a result, the second latching member 243 moves together with main body 241 and the first latching member 211 does not move, such that the second latching member 243 disengages the first latching member 211, and the first cover 21 can therefore be flipped open by other relevant forces. In the meantime, when the force pushing touching protrusion 2415 is released, the main body 241 is pushed back by the elastic portions 245 and goes back to its original position.

To fold the first cover 21, an external force is manually applied on the first cover 21. The outer surface of the first latching member 211 pushes the curved top surface 2431 of the second latching member 243 and slides down thereupon till the two latching members latch together. The first cover 21 and the second cover 22 are thus securely folded together.

In the above mentioned housing 20, when the main body 241 is pressed via the touching protrusion 2415, the second latching member 243 moves together with the main body 241 and releases from the first latching member 211, thus the first cover 21 is able to be flipped open. When the main body 241 is being pushed, a force substantially perpendicular to the main body 241 is applied thereupon and slippage between a finger and the button seldom happens, therefore the first cover 21 can easily be flipped open.

It should be pointed out that, the first latching member 211 can be a resilient hook, and the second latching member 243 can be a hook holder. In addition, the first latching member 211 and the second latching member 243 can be separated components mounted onto the first cover 21 and the main body 241 respectively.

It should be pointed out that, the elastic portions 245 and the main body 241 can be separate components connected together via connecting methods. In addition, the elastic portions 245 can be springs. For the invention, there can be only one elastic portion 245, or more than two elastic portions 245, properly positioned to push the main body 241 back to its original position.

In the illustrated embodiment, the elastic portions 245 connect the back surface 2413 of the main body 241, the elastic portions 245 create a force along a direction from the bottom surface 2413 to the contact receiving surface 2411 on the main body 241 and makes the main body 241 go back to its original position. It should be pointed out that, the elastic portion 245 can also connect the contact receiving surface 2411 of the main body 241 so that the resisting portion 2251 can be fixed on a sidewall 223 of the bottom cover 22. In this configuration, the elastic portion 245 exerts a drawn force to the main body 241.

It can be understood that, the latching housing 225 can be replaced by other configuration, such as a combination of a slide rail and a resisting member. The slide rail is configured to allow the button 24 to move and omitted, and the a resisting member is configured for resisting the elastic portion of the button 24.

It can be understood that, a plurality of elongated depression (not labeled) can be defined in the contact receiving surface 2411 in order to achieve a firm touch by a finger.

A recess also can be formed in the sidewall 223a of the second cover 22. In this configuration, the button 24 can be received in the recess and at least a portion of the contact receiving surface 2411 can be exposed out of the second cover 22, the opening 2231 can be omitted.

Finally, while various embodiments have been described and illustrated, the invention is not to be construed as being limited thereto. Various modifications can be made to the embodiments by those skilled in the art without departing from the true spirit and scope of the invention as defined by the appended claims.

What is claimed is:

1. A housing of a foldable device, comprising:
a first cover comprising a first latching member;
a button comprising:
a main body comprising a contact receiving surface and a back surface, the two surfaces being on the opposite sides of the main body;
a second latching member defined on the main body and aligned with the first latching member of the first cover and configured for engaging with the first latching member of the first cover; and
at least one elastic portion; and
a second cover comprising a resisting portion fixed on the second cover and facing towards the back surface of the main body;
wherein the at least one elastic portion is disposed between the back surface of the main body and the resisting portion of the second cover, the at least one elastic portion is capable of passing an force to push the main body away from the resisting portion; and
wherein the button is capable of being pushed towards the resisting portion via the contact receiving surface so that the second latching member moves along with the main body and disengages the first latching member.

2. The housing of the foldable device as claimed in claim 1, wherein the second cover comprises an opening, the contact receiving surface is positioned in the opening.

3. The housing of the foldable device as claimed in claim 2, wherein the second cover defines a latching housing therein, a side surface of the latching housing forms the resisting portion, the button is positioned in the latching housing.

4. The housing of the foldable device as claimed in claim 2, wherein the contact receiving surface forms a pressing portion, the second cover comprising a base and a plurality of sidewalls extending from the base, one of the sidewalls defines an opening, the pressing portion is positioned in the opening.

5. The housing of the foldable device as claimed in claim 4, wherein the pressing portion defined a plurality of depressions therein.

6. The housing of the foldable device as claimed in claim 1, wherein the button is integrally formed with the second latching member.

7. The housing of the foldable device as claimed in claim 1, wherein the elastic portion is integrally formed with the main body.

8. The housing of the foldable device as claimed in claim 1, wherein the elastic portion is an “S”-shaped elastic member.

9. The housing of the foldable device as claimed in claim 1, wherein the elastic portion and the button are separated.

10. The housing of the foldable device as claimed in claim 1, wherein the first latching member is a hook holder, and the second latching member is a resilient hook.

11. The housing of the foldable device as claimed in claim 10, wherein a top surface of the resilient hook is curved.
